(19) United States
(12) Patent Application Publication
(10) Pub. No.: US 2024/0075507 A1
(43) Pub. Date: Mar. 7, 2024

(54) A Dust Collector for a Web Perforator System

(71) Applicants: Robert E. KRAUTKRAMER, Neenah, WI (US); Matthew R. WILSON, Neenah, WI (US); Elliot LATHAM, Neenah, WI (US); Kimberly-Clark Worldwide, Inc., Neenah, WI (US)

(72) Inventors: Robert E. Krautkramer, Combined Locks, WI (US); Matthew R. Wilson, Oshkosh, WI (US); Elliot Latham, Appleton, WI (US)

(21) Appl. No.: 18/261,856

(22) PCT Filed: Feb. 26, 2021
(86) PCT No.: PCT/US2021/020001

§ 371 Date: Jul. 18, 2023

(51) Int. Cl. B08B 15/04; B62D 7/18

(52) U.S. Cl. CPC B08B 15/04; B62D 7/18; B26D 2007/0018

(57) ABSTRACT

A dust collector includes a container defining an interior volume and an opening. A scraper is positioned within the interior volume of the container, and an edge of the scraper is positioned adjacent an inner surface of the container. A collection motor is coupled to the container and is operable to rotate the container about an axis of rotation between at least a first orientation and a second orientation. The container is positioned and oriented for collecting dust within the interior volume of the container via the opening of the container in the first orientation. The container is positioned and oriented for discharging dust from the interior volume of the container via the opening of the container in the second orientation. A trough is disposed below the container. The trough is positioned for receipt of the dust from the interior volume of the container when the container is in the second orientation.

### BACKGROUND

Various methods and apparatuses for perforating a moving target web are known in the art. Certain processes and machines include a rotary knife roll and a stationary anvil that perforate the target web moving between the rotary knife roll and the stationary anvil. Moreover, blades on the rotary knife roll cut the target web when the blades impact against the stationary anvil with the target web positioned between the blades and the stationary anvil. Suitable anvils and rotary knife rolls are available from commercial vendors.

Perforating a web can generate a significant volume of dust, and the dust can negatively affect performance of machinery when the dust accumulates on or within the machinery. Thus, collecting and containing dust is an ongoing process during web perforation processes. Known dust collectors utilize vacuum hoods located adjacent dust generating areas to remove the dust to collection containers. However, dust laden with oil or other fluids can be difficult to collect using vacuum hoods and other known dust collectors.

In view of the above, a need exists for improved dust collection within web perforator systems.

### SUMMARY

In general, the present disclosure is directed to a dust collector, e.g., for a web perforator system. The dust collector includes a container and a motor that rotates the container between a collection orientation and an evacuation orientation. Dust may enter the container in the collection orientation and exit the container in the evacuation orientation. A trough disposed below the container may receive the dust from the container and the dust may then be transferred away from the dust collector. Utilizing the dust collector may facilitate collection and disposal of dust from a web perforator system. For instance, the dust collector may be positioned below and collect dust from a rotary knife roll and a stationary anvil during perforation of a target web moving between the rotary knife roll and the stationary anvil. The dust collector may advantageously collect oil and/or other fluid laden dust in such example embodiments.

In one example embodiment, a dust collector includes a container defining an interior volume and an opening. A scraper is positioned within the interior volume of the container, and an edge of the scraper is positioned adjacent an inner surface of the container. A collection motor is coupled to the container and is operable to rotate the container about an axis of rotation between at least a first orientation and a second orientation. The container is positioned and oriented for collecting dust within the interior volume of the container via the opening of the container in the first orientation. The container is positioned and oriented for discharging dust from the interior volume of the container via the opening of the container in the second orientation. A trough is disposed below the container. The trough is positioned for receipt of the dust from the interior volume of the container when the container is in the second orientation.

In a first example aspect, the container may be a cylindrical container. The cylindrical container may include a curved side wall, and the opening of the container may be defined between opposite edges of the curved side wall. The cylindrical container may be a cylindrical plastic container. A diameter of the cylindrical container may be no less than twenty centimeters and no greater than fifty centimeters. A central angle may intersect the opposite edges of the curved side wall in a cross-section of the container that is perpendicular to the axis of rotation. The central angle may be no less than sixty degrees (60°) and no greater than one hundred and twenty degrees (120°).

In a second example aspect, the scraper may be an interior scraper, and the dust collector may include an exterior scraper. An edge of the exterior scraper may be positioned adjacent an outer surface of the container. The exterior scraper may be positioned directly above the trough.

In a third example aspect, a vertical axis may intersect a center of the interior volume. A first side of the interior volume may be positioned opposite a second side of the interior volume about the vertical axis. No less than eighty percent (80%) of the opening may be positioned on the first side of the interior volume when the container is in the first orientation, and the edge of the scraper may be positioned on the second side of the interior volume.

In a fourth example aspect, the dust collector may include an ejector. In certain example aspects, the ejector may include a shaft, an ejector plate coupled to the shaft, and an ejector motor coupled to the shaft and operable to rotate the shaft in order to laterally translate the ejector plate within the trough. The ejector plate may be configured to laterally move the dust out of the trough when the ejector plate laterally translates within the trough. In alternative example aspects, the ejector may include one or both of a conveyor belt or conveyor chain positioned at a bottom of the trough.

In a fifth example aspect, a hopper plate may be disposed directly below the container. The hopper plate may slope downwardly towards the trough. A width of the hopper plate along a lateral direction may be about equal to a width of the container along the lateral direction. The lateral direction may be parallel to the axis of rotation.

In a sixth example aspect, the dust collector may include a flexible traction drive extending between and coupling the collection motor and the container. The flexible traction drive may include a belt or a chain.

In a seventh example aspect, the opening of the container may face upwardly in the first orientation, and the opening of the container may face downwardly in the second orientation.

In an eighth example aspect, a width of the container along a lateral direction may be no less than one hundred and fifty centimeters (150 cm) and no greater than three hundred and fifty centimeters (350 cm). The lateral direction may be parallel to the axis of rotation.

In a nineth example aspect, a perforation system for a web may include at least one set of perforation rolls and the dust collector. The at least one set of perforation rolls may include a knife member and an anvil member. The dust collector may be positioned below the at least one set of perforation rolls and may be configured for collecting dust from the at least one set of perforation rolls. An idler roller may be positioned between the at least one set of perforation rolls and the dust collector. The idler roller may be configured for guiding the web around the duct collector after the web is perforated by the knife member and the anvil member. A vertical gap between the dust collector and the at least one set of perforation rolls may be no less than twenty centimeters (20 cm) and no greater than sixty centimeters (60 cm).

Each of the example aspects recited above may be combined with one or more of the other example aspects recited above in certain embodiments. For instance, all of the nine example aspects recited above may be combined with one another in some embodiments. As another example, any combination of two, three, four, five, or more of the nine example aspects recited above may be combined in other embodiments. Thus, the example aspects recited above may be utilized in combination with one another in some example embodiments. Alternatively, the example aspects recited above may be individually implemented in other example embodiments. Accordingly, it will be understood that various example embodiments may be realized utilizing the example aspects recited above.

These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures.

FIG. 1 is a schematic view of a perforation system with a dust collector according to an example embodiment of the present disclosure with a container of the example dust collector shown in a first orientation.

FIG. 2 is a schematic view of the perforation system of FIG. 1 with the container of the example dust collector shown in a second orientation.

FIG. 3 is a perspective view of certain components of the example dust collector of FIG. 1.

FIG. 4 is a perspective view of a trough and ejector of the example dust collector of FIG. 1 with an ejector plate shown in a first position in the trough.

FIG. 5 is a perspective view of the trough and ejector of the example dust collector of FIG. 1 with the ejector plate shown in a second position in the trough.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

Example embodiments of the present disclosure are directed to a dust collector for a web perforator system. The dust collector may be positioned below perforation rolls in the web perforator system. Dust generated between the perforation rolls may drop downwardly into the container. Thus, the dust collector may advantageously collect dust within the web perforator system. For instance, oil or other fluid laden dust may be generated in the web perforator system, and the dust collector may advantageously collect such oil or other fluid laden dust. Dust collector also includes features for removing the collected dust from the duct collector. Thus, utilizing the dust collector may advantageously facilitate collection and disposal of dust from the web perforator system.

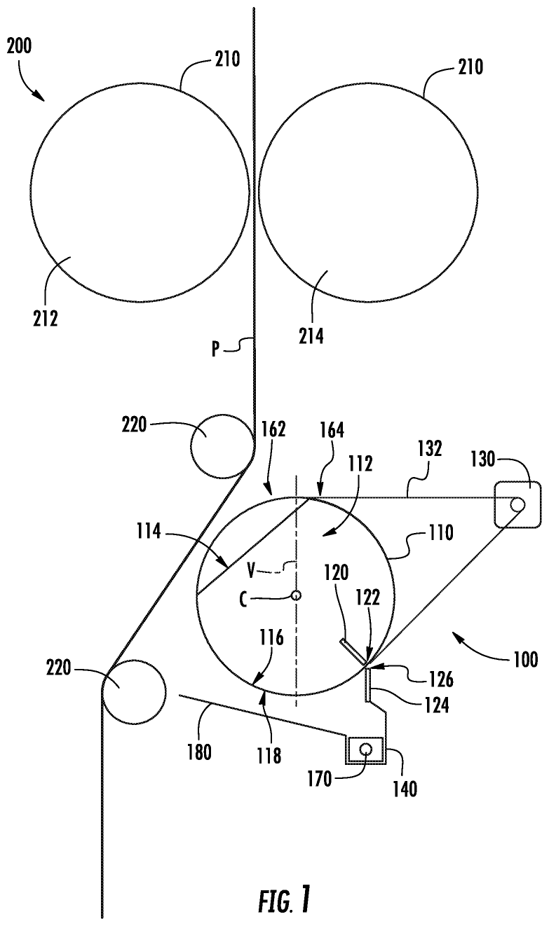

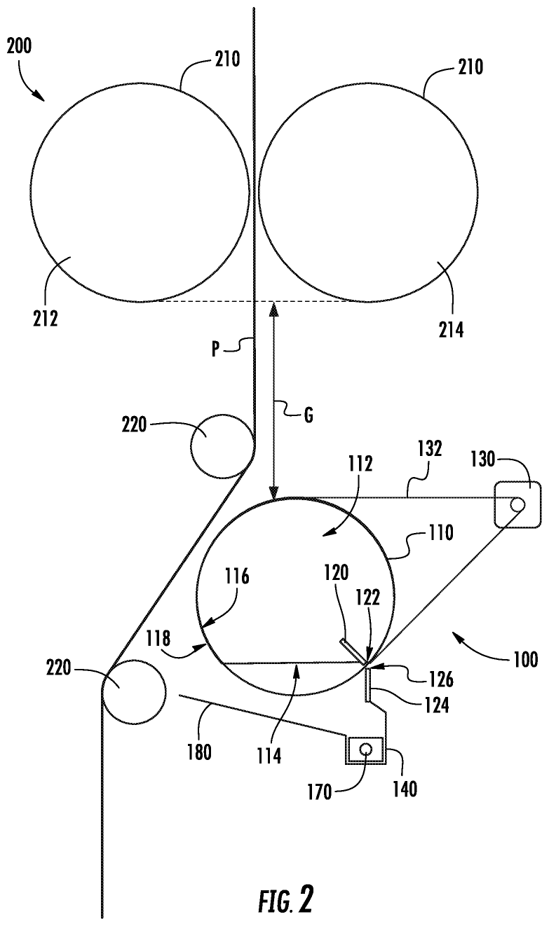

With reference to FIGS. 1 and 2, a dust collector 100 according to an example embodiment of the present disclose is shown. Dust collector 100 may be used in or with any suitable machinery for collecting dust. For instance, dust collector 100 may be used with a perforator 200. Thus, dust collector 100 is described in greater detail below in the context of perforator 200. However, it will be understood that dust collector 100 may be used with other suitable perforators, winders, web-making machinery, etc. in alternative example embodiments. For instance, dust collector 100 may be utilized in or with a wide range of manufacturing systems that include high-speed cutting of selected web materials and/or manufacture of tissue webs and products. Moreover, dust collector 100 may be utilized in machinery used to make facial tissue, bath tissue, wipes, toweling, disposable personal care articles, disposable absorbent articles, or the like.

Perforator 200 may be any suitable device for perforating a target web P, such as a conventional perforating apparatus. For the sake of brevity, perforator 200 is not described extensively herein. However, with reference to FIGS. 1 and 2, perforator 200 may include at least one set of perforation rolls 210, including a knife roll 212 and an anvil roll 214. Perforator 200 is well suited for cutting a line of perforations in the moving target web P. The target web P may include one or more selected materials. The target web P may include a single layer or multiple layers. The multiple layers may differ from one another or may be substantially the same. Optionally, the target web P may include a combination of one or more additional webs of material. Any suitable web material may be employed. In certain example embodiments, the web material is a fibrous tissue web having a low basis weight, such as from ten grams per square meter (10 g/m²) to one hundred grams per square meter (100 g/m²), high bulk, such as greater than three cubic centimeters per gram (3 cm 3/g), and including one or more plies.

In use, the web P to be perforated travels though perforator 200 in a machine-direction (“MD”) which extends transversely to the cross-machine direction (“CD”). For the purposes of the present disclosure, the MD is the direction along which a particular component or material is transported length-wise along and through a particular, local position of the apparatus and method. The CD is aligned perpendicular to the MD along the local plane of the material targeted for work and may lie generally parallel to the local horizontal. As target web P passes through perforator 200, target web P is intermittently cut to provide lines of perforations. Generally, perforation of target web P is achieved by a cutting action as target web P passes between a knife blade on the knife roll 212 and an anvil on the anvil roll 214.

As discussed herein the knife blade generally refers to a blade having alternately spaced teeth and notches across a portion of the blades leading edge, while the anvil generally has a substantially constant height along a length of the anvil. One skilled in the art will appreciate, however, that the position of the knife blade and the anvil may be switched without affecting the performance or operation of the system and apparatus. For example, the rotating roll may be provided with one or more anvils and a stationary roll may be provided with a knife blade that is contacted by the one or more rotating anvils. For simplicity however, the present invention will generally be described with reference to the figures, which illustrate an embodiment in which the knife roll 212 is a rotating knife roll and the anvil roll 214 is a stationary anvil roll.

During operation of perforator 200, dust is generated, e.g., due to the cutting of the target web P between the knife blade on the knife roll 212 and the anvil on the anvil roll 214. The dust from perforator 200 may be laden with oil or other fluids. In certain example embodiments, a lubricant may be applied to the target web P in perforator 200. Examples of lubricants include, for example, polyethers, glycol, polyolefins, silicone, fluorocarbons, grease, graphite, animal oils, vegetable oils, mineral oils, and combinations thereof. Particularly preferred lubricants are mineral oil and still more preferably white mineral oil. By “white mineral oil,” it is herein intended very highly refined oils which consist entirely of saturated components, all aromatics having generally been removed by treatment with fuming sulfuric acid or by selective hydrogenation.

As discussed in greater detail below, dust collector 100 includes features for collecting and removing dust from perforator 200. For instance, dust collector 100 may be positioned and configured for collecting oil or other fluid laden dust from perforator 200 and for transferring the collected dust away from perforator 200. Thus, dust collector 100 may advantageously facilitate operation of perforator 200 and/or assist with providing a safe operator area adjacent perforator 200. To allow installation and operation of dust collector 100 within perforator 200, dust container 110 may be sized to occupy a compact volume, e.g., as described below.

As shown in FIGS. 1 and 2, dust collector 100 includes a container 110 and a collection motor 130. Container 110 defines an interior volume 112 and an opening 114. Collection motor 130 is operable to rotate container 110 between at least a first orientation (FIG. 1) and a second orientation (FIG. 2). In the first orientation, container 110 may be positioned and oriented for collecting dust within interior volume 112 of container 110 via opening 114 of container 110. For instance, as shown in FIG. 1, opening 114 of container 100 may be positioned below and face upwardly towards perforator 200, e.g., perforation rolls 210, in the first orientation. Thus, e.g., dust from target web P, e.g., that is generated when target web P is cut between the knife blade on knife roll 212 and the anvil on anvil roll 214, may fall downwardly from perforator 200 into interior volume 112 of container 110 via opening 114. As another example, an idler roller 220 may be positioned directly over opening 114 of container 110 in the first orientation, and dust on web P may be ejected towards opening 114 as the web P turns on idler roller 220. As may be seen from the above, container 110 may be positioned and oriented for collecting dust generated from web B while container 110 is in the first orientation. In certain example embodiments, a vertical gap G (FIG. 2) between dust collector 100 (e.g., the uppermost portion of opening 114) and perforation rolls 210 (e.g., the lowermost portion of knife roll 212 or anvil roll 214) may be no less than twenty centimeters (20 cm) and no greater than sixty centimeters (cm). Such spacing between dust collector 100 and perforation rolls 210 may facilitate collection of dust from perforator 200 within container 110. Moreover, such spacing between dust collector 100 and perforation rolls 210 demonstrates the limited space available below perforator 200 within which dust collector 100 is configured for operating. After collecting dust within interior volume 112 of container 110 in the first orientation, collection motor 130 may rotate container 110 from the first orientation to the second orientation.

During rotation of container 110 from the first orientation to the second orientation, the dust within interior volume 112 of container 110 may move towards opening 114, e.g., due to gravity and/or one or more scrapers 120, 124, in order to evacuate the collected dust within interior volume 112 out of container 110. Moreover, in the second orientation, container 110 may be positioned and oriented for discharging dust from interior volume 112 of container 110 through opening 114 of container 110. For instance, as shown in FIG. 2, opening 114 of container 100 may face downwardly, e.g., away from perforator 200 in the second orientation. Thus, e.g., collected dust within interior volume 112 may be discharged from container 110 through opening 114 and may fall downwardly away from container 112.

Dust collector 100 may also include scrapers 120, 124 that assist with moving dust within interior volume 112 towards opening 114 when container 110 rotates from the first orientation to the second orientation. For example, dust collector 100 may include an interior scraper 120 and/or an exterior scraper 124. Interior scraper 120 may be positioned within interior volume 112 of container 110, and an edge 122 of interior scraper 120 may be positioned adjacent an inner surface 116 of container 110, e.g., that faces interior volume 112 of container 110. Interior scraper 120 may be a squeegee, blade, plate, etc. that scrapes, pushes, or otherwise moves accumulated dust on inner surface 116 of container 110 towards opening 114 while container 110 rotates from the first orientation to the second orientation. Exterior scraper 124 may be positioned outside of container 110, and an edge 126 of exterior scraper 124 may be positioned adjacent an outer surface 118 of container 110, e.g., that faces away from interior volume 112 of container 110. Thus, e.g., exterior scraper 124 may be positioned opposite interior scraper 120 about container 110. Exterior scraper 124 may be a squeegee, blade, plate, etc. that scrapes, pushes, or otherwise moves accumulated dust on outer surface 118 of container 110 off of outer surface 118 while container 110 rotates from the first orientation to the second orientation.

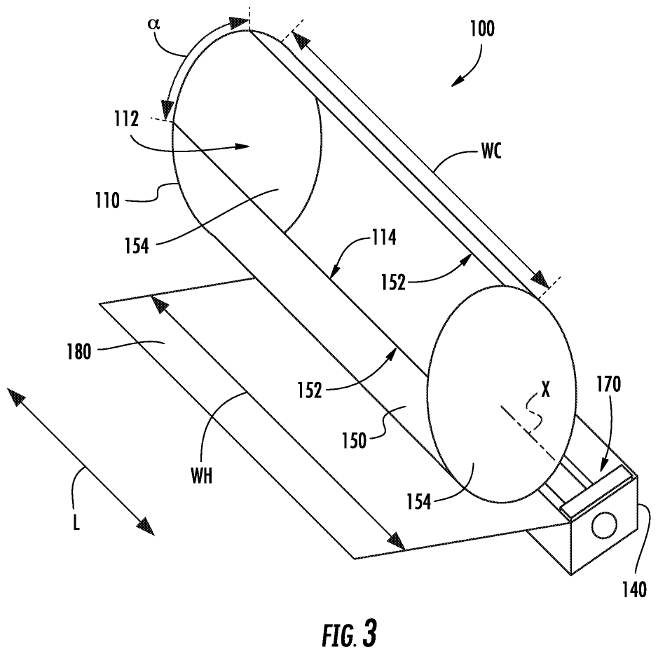

The sizing and/or construction of container 110 may facilitate collection of dust by container 110. As an example, turning now to FIG. 3, container 110 may be a cylindrical container, e.g., and thus have a generally circular cross-section in a plane that is perpendicular to the axis of rotation X, and may be constructed of a suitable plastic, such as polyvinyl chloride (PVC). A diameter of container 110 may be no less than twenty centimeters (20 cm) and no greater than fifty centimeters (50 cm) in certain example embodiments. In some example embodiments, the diameter of container 110 may be about ten centimeters (10 cm), about twenty centimeters (20 cm), about thirty centimeters (30 cm), about forty centimeters (40 cm), about fifty centimeters (50 cm), about sixty centimeters (60 cm), or more. Container 110 may include a curved side wall 150 and a pair of end walls 154. Each end wall 154 may be positioned at an opposite, respective end of curved side wall 150. Thus, end walls 154 may be spaced apart from each other, e.g., along a lateral direction L that is parallel to the axis of rotation X. Opening 114 of container 110 may be defined between opposite edges 152 of curved side wall 150, e.g., such that opening 114 extends circumferentially between opposite edges 152. Opening 114 may also extend between end walls 154, e.g., along the lateral direction L. In addition, a central angle α of opening 114 may intersect the opposite edges 152 of curved side wall 150, e.g., in a cross-section of container 110 that is perpendicular to the axis of rotation X. The central angle α may be selected to facilitate collection of dust. For instance, the central angle α may be is no less than sixty degrees (60°) and no greater than one hundred and twenty degrees (120°). Such sizing of opening 114 may facilitated collection of dust within interior volume 112, e.g., by providing a suitably large opening facing towards perforator 200 in the first orientation. In some example embodiments, the central angle α may be about fifty degrees (50°), about sixty degrees (60°), about ninety degrees (90°), about one hundred and twenty degrees (120°), about one hundred and thirty degrees (130°), or about one hundred and eighty degrees (180°). While shown with only one opening 114 in the example embodiment shown in FIG. 3, it will be understood that container 110 may include a plurality of openings that collectively provide the sizing described above for opening 114. As another example, an additional opening sized in the same or similar manner to opening 114 may be defined opposite opening 112 on container 110.

As noted above, collection motor 130 is operable to rotate container 110 between at least the first orientation (FIG. 1) and the second orientation (FIG. 2). Moreover, collection motor 130 may be coupled to container 100 and may be operable to rotate container 110 about an axis of rotation X between various orientations, including the first and second orientations. Collection motor 130 may be coupled to container 110 in any suitable manner that allows for collection motor 130 to drive rotation of container 110 about the axis of rotation X. For example, as shown in FIGS. 1 and 2, a flexible traction drive 132 may extend between and couple collection motor 130 and container 110. Flexible traction drive 132 may include a belt or a chain in certain example embodiments. Thus, e.g., collection motor 130 may include a gear wheel or pully connected to a rotor of collection motor 130, and container 110 may include a corresponding gear wheel or pully, e.g., at the outer surface 118 of container 110. Flexible traction drive 132 may be extend between and connect the gear wheels or pullies of collection motor 130 and container 110 in order to transfer rotation of collection motor 130 to container 110.

Collection motor 130 may be operable to rotate container 110 in only a single rotational direction in certain example embodiments. For instance, collection motor 130 may rotate container 110 counterclockwise in the view shown in FIGS. 1 and 2. Thus, e.g., collection motor 130 may rotate container 110 in the single rotational direction from the first orientation to the second orientation and continue to rotate container 110 in the single rotational direction to return the container 110 from the second orientation back to the first orientation. Such single rotational direction may facilitate removal of dust from container 110 with scrapers 120, 124, which are described in greater detail below. Moreover, the single rotational direction provided by collection motor 130 for container 110 may allow for simple control of collection motor 130. However, it will be understood that collection motor 130 may be configured for rotating container 110 in two rotational directions in alternative example embodiments, e.g., such that the collection motor 130 rotates container 110 from the first orientation to the second orientation in one rotational direction and rotates container 110 from the second orientation to the first orientation in the opposite rotational direction in order to return the container 110 to the first orientation.

As may be seen from the above, container 110 may be selectively rotatable in order to collect and discharge dust. In particular, container 110 may be positioned to collect dust within interior volume 112 and then be rotated to discharge the collected dust. Dust collector 100 may also include a trough 140 for receiving the dust discharged from container 110.

Trough 140 may be disposed below container 110. In addition, trough 140 may be positioned for receiving dust from interior volume 112 of container 110 when container 110 is in the second orientation. For example, dust within interior volume 112 of container 110 may move towards opening 114 dues to gravity and/or interior scraper 120 while container 110 rotates towards the second orientation. The dust exiting container through opening 114 may fall downwardly onto a hopper plate 180 and/or directly into trough 140. Hopper plate 180 may be sloped to direct dust on hopper plate 180 towards trough 140. For example, hopper plate 180 may slope downwardly towards trough 140, e.g., such that a bottom edge of hopper plate 180 is positioned at or over trough 140. Trough 140 may also be positioned to receive dust from exterior scraper 124. For example, trough 140 may be positioned directly below exterior scraper 124, and dust from outer surface 118 of container 110 harvested by exterior scraper may fall downwardly onto hopper plate 180 and/or directly into trough 140 while container 110 rotates towards the second orientation. Thus, exterior scraper 124 may be positioned to remove dust on outer surface 118 to trough 140. As may be seen from the above, trough 140 may receive and collect dust from inner and outer surfaces 116, 118 of container 110.

Container 110, trough 140, and/or hopper plate 180 may be sized to facilitate collection of dust. For instance, a width WC of container 110, e.g., along a lateral direction L, may be no less than one hundred and fifty centimeters (150 cm) and no greater than three hundred and fifty centimeters (350 cm). As another example, the width WC of container 110, e.g., along the lateral direction L, may be no less than two hundred centimeters (200 cm) and no greater than three hundred centimeters (300 cm). As yet another example, the width WC of container 110, e.g., along the lateral direction L, may be about equal to a width of the web P, e.g., along the cross-machine direction (“CD”). Such lateral sizing of container 110 may facilitate collection of dust from perforator 200 during perforation of web materials and/or manufacture of tissue webs and products. A width WH of hopper plate 180, e.g., along the lateral direction L, may be no less than the width WC of container 110. Similarly, a width WT of trough 140, e.g., along the lateral direction L, may be no less than the width WC of container 110. The width WT of trough 140 may be about equal to the width WH of hopper plate 180. Such sizing of container 110, trough 140, and/or hopper plate 180 may facilitate collection of dust from container 110 onto hopper plate 180 and/or into trough 140. In certain example embodiments, a vertical gap between container 110 (e.g., the bottommost portion of container 110) and trough 140, and/or hopper plate 180 (e.g., the uppermost portion of trough 140, or hopper plate 180) may be no less than twenty centimeters (20 cm) and no greater than sixty centimeters (cm).

Turning back to FIG. 1, in certain example embodiments, a vertical axis V may intersect a center C of interior volume 112. A first side 162 of interior volume 112 may be positioned opposite a second side 164 of interior volume 112 about the vertical axis V. A majority of opening 114, e.g., no less than eighty percent (80%) of opening 114 may be positioned on first side 116 of interior volume 112 when container 110 is in the first orientation, and edge 122 of interior scraper 120 may be positioned on second side 164 of interior volume 112. Thus, the majority of opening 114 may be positioned opposite edge 122 of interior scraper 120 about the vertical axis V when container 110 is in the first orientation. Such relative positioning of opening 114 and interior scraper 120 may facilitate collection and removal of dust within interior volume 112.

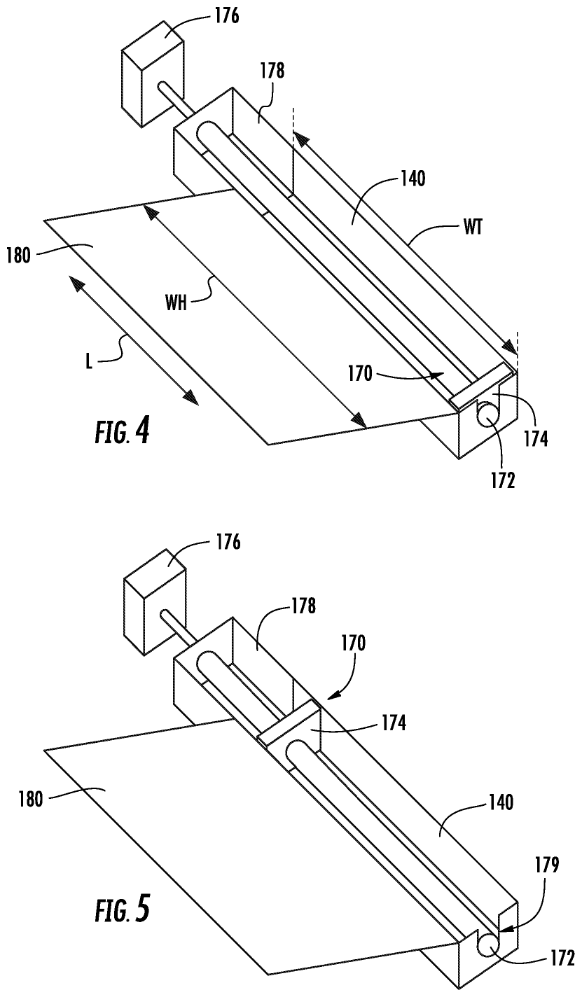

Turning to FIGS. 4 and 5, dust collector 100 may also include an ejector 170 for removing duct from trough 140. Ejector 170 may include a shaft 172, an ejector plate 174, and an ejector motor 176. Ejector plate 174 may be positioned within trough 140 and may be shaped complementary to an interior cross-section of trough 140, e.g., in a plane that is perpendicular to the lateral direction L. In addition, ejector plate 174 may be coupled to shaft 172. For example, ejector plate 174 may be threaded onto shaft 172. Ejector motor 176 may be coupled to shaft and operable to rotate shaft 172 in order to translate ejector plate 174, e.g., along the lateral direction L, within trough 140. Thus, ejector plate 174 may be configured to move dust within trough 140, e.g., along the lateral direction L, out of trough 140 when ejector plate 174 laterally translates within trough 140. For instance, a funnel 178 may be positioned at an end of trough 140, and ejector plate 174 may be normally positioned within trough 140 opposite funnel 178. When ejector motor 176 operates to rotate shaft 172 and thus translate ejector plate 174, e.g., along the lateral direction L, within trough 140, ejector plate 174 may push the dust within trough towards and into funnel 178. From funnel 178, the dust may be mixed with water and pumped to a waste holding tank (not shown).

It will be understood that the ejector 170 shown in FIGS. 4 and 5 is provided by way of example only. In alternative example embodiments, ejector 170 may include a continuous discharge ejector for removing duct from trough 140. For example, a conveyor belt and/or a conveyor chain may be positioned at a bottom of trough 140 such that dust entering trough 140 collects on the conveyor belt or conveyor chain. To remove dust collected within trough 140, the conveyor belt or profiled conveyor chain at the bottom of trough 140 may operate to move dust within trough 140, e.g., along the lateral direction L, out of trough 140 and/or to funnel 178. A continuous discharge ejector may advantageously avoid using ejector plate 174, which requires ejector plate 174 to laterally translate within trough 174, e.g., such that dust may collect behind ejector plate 174 at the end of trough 140 opposite funnel 178.

An example method of operating dust collector 100 may include: positioning container 110 below perforation rolls 210 in the first orientation such that opening 114 of container 110 faces towards perforation rolls 210; when container 110 is in the first orientation, receiving dust from web P moving between perforation rolls 210 within interior volume 112 of container 110 through opening 114 of container 110; rotating container 110 from the first orientation to a second orientation with collection motor 130 coupled to container 110; during the rotation of container 110 from the first orientation to the second orientation, moving dust on inner surface 116 of container 110 towards opening 114 of container 110 with interior scraper 120; as the container rotates to the second orientation, discharging dust from interior volume 112 of container 110 via opening 114 of container 110; and receiving the dust from interior volume 112 of container 110 into trough 140 disposed below container 110.

Utilizing a dust collector according to the present disclose may assist with effective dust collection of moist, oil or other fluid laden dust during perforation of a web. The rotating dust collector occupies a compact envelope within an associated perforator and/or an associated winder. Dust falling from perforator rolls in a winder may fall into an opening in a container of the dust collector while the container is stationary, and the container may collect the moist, oil or other fluid laden dust, e.g., like a catch pan. After a period of time and/or when a sensor detects that the container is full, the container is rotated to deposit the dust within a trough below the container. Dust that accumulates on an exterior of the container may also be collected and deposited in the trough. The dust within the trough may be linearly conveyed to a collection funnel, mixed with water, and pumped to a waste tank.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

### Example Embodiments

First example embodiment: A dust collector (100), comprising: a container (110) defining an interior volume (112) and an opening (114); a scraper (120) positioned within the interior volume (112) of the container (110), an edge (122) of the scraper (120) positioned adjacent an inner surface (116) of the container (110); a collection motor (130) coupled to the container and operable to rotate the container (110) about an axis of rotation (X) between at least a first orientation and a second orientation, the container (110) positioned and oriented for collecting dust within the interior volume (120) of the container (110) via the opening (114) of the container (110) in the first orientation, the container (110) positioned and oriented for discharging dust from the interior volume (112) of the container (110) via the opening (114) of the container (110) in the second orientation; and a trough (140) disposed below the container (110), the trough (140) positioned for receipt of the dust from the interior volume (112) of the container (110) when the container (110) is in the second orientation.

Second example embodiment: The dust collector (100) of the first example embodiment, wherein the container (110) is a cylindrical container, the cylindrical container comprises a curved side wall (150), and the opening (114) of the container (110) is defined between opposite edges (142) of the curved side wall (150).

Third example embodiment: the dust collector (100) of the first or the second example embodiment, wherein the cylindrical container is a cylindrical plastic container.

Fourth example embodiment: The dust collector (100) of any one of the first through third example embodiments, wherein a diameter (D) of the cylindrical container is no less than twenty centimeters and no greater than fifty centimeters.

Fifth example embodiment: The dust collector (100) of one of any one of the first through fourth example embodiments, wherein a central angle (a) intersects the opposite edges (152) of the curved side wall (150) in a cross-section of the container (110) that is perpendicular to the axis of rotation (X), and the central angle (a) is no less than sixty degrees and no greater than one hundred and twenty degrees.

Sixth example embodiment: The dust collector (100) of one of any one of the first through fifth example embodiments, wherein the scraper (120) is an interior scraper, the dust collector further comprises an exterior scraper (124), and an edge (126) of the exterior scraper (124) is positioned adjacent an outer surface (118) of the container (110).

Seventh example embodiment: The dust collector (100) of one of any one of the first through sixth example embodiments, wherein the exterior scraper (124) is positioned directly above the trough (140).

Eighth example embodiment: The dust collector (100) of one of any one of the first through seventh example embodiments, wherein a vertical axis (V) intersects a center (160) of the interior volume (112), a first side (162) of the interior volume (112) is positioned opposite a second side (164) of the interior volume (112) about the vertical axis (V), no less than eighty percent of the opening (114) is positioned on the first side (162) of the interior volume (112) when the container (110) in the first orientation, and the edge (122) of the scraper (120) is positioned on the second side (164) of the interior volume (112).

Nineth example embodiment: The dust collector (100) of one of any one of the first through eighth example embodiments, further comprising an ejector (170). The ejector (170) comprising: a shaft (172); an ejector plate (174) coupled to the shaft (172); and an ejector motor (176) coupled to the shaft (172) and operable to rotate the shaft (172) in order to laterally translate the ejector plate (174) within the trough (140), the ejector plate (174) configured to laterally move the dust out of the trough (140) when the ejector plate (174) laterally translates within the trough (140). Alternatively, the ejector (170) comprises one or both of a conveyor belt or conveyor chain positioned at a bottom of the trough (140).

Tenth example embodiment: The dust collector (100) of one of any one of the first through nineth example embodiments, further comprising a hopper plate (180) disposed directly below the container (110), the hopper plate (180) sloping downwardly towards the trough (140).

Eleventh example embodiment: The dust collector (100) of one of any one of the first through tenth example embodiments, wherein a width (WH) of the hopper plate (180) along a lateral direction (L) is about equal to a width (WC) of the container (110) along the lateral direction (L), and the lateral direction (L) is parallel to the axis of rotation (X).

Twelfth example embodiment: The dust collector (100) of one of any one of the first through eleventh example embodiments, further comprising a flexible traction drive (132) extending between and coupling the collection motor (130) and the container (110), the flexible traction drive (132) comprising a belt or a chain.

Thirteenth example embodiment: The dust collector (100) of one of any one of the first through twelfth example embodiments, wherein the opening (114) of the container (110) faces upwardly in the first orientation, and the opening (114) of the container (110) faces downwardly in the second orientation.

Fourteenth example embodiment: The dust collector (100) of one of any one of the first through thirteenth example embodiments, wherein a width (WC) of the container (110) along a lateral direction (L) is no less than one hundred and fifty hundred centimeters and no greater than three hundred and fifty centimeters, and the lateral direction (L) is parallel to the axis of rotation (X).

Fifteenth example embodiment: A perforation system (200) for a web (P), comprising: at least one set of perforation rolls (210) comprising a knife member (212) and an anvil member (214); and the dust collector (100) of one of any one of the first through fourteenth example embodiments, wherein the dust collector (100) is positioned below the at least one set of perforation rolls (210) and is configured for collecting dust from the at least one set of perforation rolls (210).

Sixteenth example embodiment: The perforation system of the fifteenth example embodiment, further comprising an idler roller (220) positioned between the at least one set of perforation rolls (210) and the dust collector (100), the idler roller (220) configured for guiding the web (P) around the duct collector (100) after the web (P) is perforated by the knife member (212) and the anvil member (214).

Seventeenth example embodiment: The perforation system of the fifteenth or sixteenth example embodiments, wherein a vertical gap (G) between the dust collector (100) and the at least one set of perforation rolls (210) is no less than twenty centimeters and no greater than sixty centimeters.

Eighteenth example embodiment: A method for collecting dust from perforation rolls (210), comprising: positioning a container (110) below the perforation rolls (210) in a first orientation such that an opening (114) of the container (110) faces towards the perforation rolls (210); when the container (110) is in the first orientation, receiving dust from a web (P) moving between the perforation rolls (210) within an interior volume (112) of the container (110) through the opening (114) of the container (110); rotating the container (110) from the first orientation to a second orientation with a collection motor (130) coupled to the container (110); during the rotation of the container (110) from the first orientation to the second orientation, moving dust on an inner surface (116) of the container (110) towards the opening (114) of the container (110) with a scraper (120), the scraper (120) positioned within the interior volume (112) of the container (110) such that an edge (122) of the scraper (110) is adjacent the inner surface (116) of the container (110); as the container (110) rotates to the second orientation, discharging dust from the interior volume (112) of the container (110) via the opening (114) of the container (110); and receiving the dust from the interior volume (112) of the container (110) into a trough (140) disposed below the container (110).

### REFERENCE CHARACTERS

100 Dust collector
110 Container
112 Interior volume
114 Opening
116 Inner surface
118 Outer surface
120 Interior scraper
122 Edge
124 Exterior scraper
126 Edge
130 Collection motor
132 Flexible traction drive
140 Trough
150 Curved sidewall
152 Edges
154 End walls
160 Center
162 First side
164 Second side
170 Ejector
172 Shaft
174 Ejector plate
176 Ejector motor
178 Funnel
179 Slot
180 Hopper plate
200 Perforator
210 Perforation rolls
212 Knife
214 Anvil
220 Idler rolls
α Central angle
X Axis of rotation
V Vertical axis
L Lateral direction
WH Width of hopper plate
WT Width of trough
WC Width of container
P Paper web
G Gap

1. A dust collector, comprising:
a container defining an interior volume and an opening;
a scraper positioned within the interior volume of the container, an edge of the scraper positioned adjacent an inner surface of the container;
a collection motor coupled to the container and operable to rotate the container about an axis of rotation between at least a first orientation and a second orientation, the container positioned and oriented for collecting dust within the interior volume of the container via the opening of the container in the first orientation, the container positioned and oriented for discharging dust from the interior volume of the container via the opening of the container in the second orientation; and
a trough disposed below the container, the trough positioned for receipt of the dust from the interior volume of the container when the container is in the second orientation.

2. The dust collector of claim 1, wherein the container is a cylindrical container, the cylindrical container comprises a curved side wall, and the opening of the container is defined between opposite edges of the curved side wall.

3. The dust collector of claim 1, wherein the container is a cylindrical plastic container.

4. The dust collector of claim 2, wherein a diameter of the cylindrical container is no less than twenty centimeters and no greater than fifty centimeters.

5. The dust collector of claim 2, wherein a central angle intersects the opposite edges of the curved side wall in a cross-section of the container that is perpendicular to the axis of rotation, and the central angle is no less than sixty degrees and no greater than one hundred and twenty degrees.

6. The dust collector of claim 1, wherein the scraper is an interior scraper, the dust collector further comprises an exterior scraper, and an edge of the exterior scraper is positioned adjacent an outer surface of the container.

7. The dust collector of claim 6, wherein the exterior scraper is positioned directly above the trough.

8. The dust collector of claim 1, wherein a vertical axis intersects a center of the interior volume, a first side of the interior volume is positioned opposite a second side of the interior volume about the vertical axis, no less than eighty percent of the opening is positioned on the first side of the interior volume when the container is in the first orientation, and the edge of the scraper is positioned on the second side of the interior volume.

9. The dust collector of claim 1, further comprising an ejector, the ejector comprising:
a shaft;
an ejector plate coupled to the shaft; and
an ejector motor coupled to the shaft and operable to rotate the shaft in order to laterally translate the ejector plate within the trough, the ejector plate configured to laterally move the dust out of the trough when the ejector plate laterally translates within the trough.

10. The dust collector of claim 1, further comprising an ejector, the ejector comprising one or both of a conveyor belt and a conveyor chain positioned at a bottom of the trough, the one or both of the conveyor belt and the conveyor chain configured to laterally move the dust out of the trough.

11. The dust collector of claim 1, further comprising a hopper plate disposed directly below the container, the hopper plate sloping downwardly towards the trough.

12. The dust collector of claim 11, wherein a width of the hopper plate along a lateral direction is about equal to a width of the container along the lateral direction, and the lateral direction is parallel to the axis of rotation.

13. The dust collector of claim 1, further comprising a flexible traction drive extending between and coupling the collection motor and the container, the flexible traction drive comprising a belt or a chain.

14. The dust collector of claim 1, wherein the opening of the container faces upwardly in the first orientation, and the opening of the container faces downwardly in the second orientation.

15. The dust collector of claim 1, wherein a width of the container along a lateral direction is no less than one hundred and fifty centimeters and no greater than three hundred and fifty centimeters, and the lateral direction is parallel to the axis of rotation.

16. A perforation system for a web, comprising:
at least one set of perforation rolls comprising a knife member and an anvil member; and
the dust collector of claim 1,
wherein the dust collector is positioned below the at least one set of perforation rolls and is configured for collecting dust from the at least one set of perforation rolls.

17. The perforation system of claim 16, further comprising an idler roller positioned between the at least one set of perforation rolls, the idler roller configured for guiding the web around the dust collector after the web is perforated by the knife member and the anvil member.

18. The perforation system of claim 16, wherein a vertical gap between the dust collector and the at least one set of perforation rolls is no less than twenty centimeters and no greater than sixty centimeters.

19. A method for collecting dust from perforation rolls, comprising:
positioning a container below the perforation rolls in a first orientation such that an opening of the container faces towards the perforation rolls,
when the container is in the first orientation, receiving dust from a web moving between the perforation rolls within an interior volume of the container through the opening of the container;
rotating the container from the first orientation to a second orientation with a collection motor coupled to the container;
during the rotation of the container from the first orientation to the second orientation, moving dust on an inner surface of the container towards the opening of the container with a scraper, the scraper positioned within the interior volume of the container such that an edge of the scraper is adjacent the inner surface of the container;
as the container rotates to the second orientation, discharging dust from the interior volume of the container via the opening of the container; and
receiving the dust from the interior volume of the container into a trough disposed below the container.
